(19) United States
(12) Patent Application Publication
(10) Pub. No.: US 2002/0154985 A1
(43) Pub. Date: Oct. 24, 2002

(54) Automatic dipping machine

(75) Inventors: David Huang, Chang Hua Hsien (TW); Ming-Tsung Yen, Kaohsiung City (TW)

Correspondence Address: DOUGHERTY & TROXELL, SUITE 1404, 5205 LEESBURG PIKE, FALLS CHURCH, VA, 22041, US

(73) Assignee: Schmidt Scientific Taiwan Ltd.

(21) Appl. No.: 09/948,589

(22) Filed: Sep. 10, 2001

(30) Foreign Application Priority Data
Apr. 20, 2001 (TW) 90206297

(51) Int. Cl. B65G 47/248

(52) U.S. Cl. 414/758; 414/783

(57) ABSTRACT

An automatic dipping machine consists of a loading platform, a carrier platform, a vacuum suction disk and a lifting means. The loading platform is a rectangular frame and has two sides mounted respectively with a turning shaft and engaged with two sides of the carrier platform for turning the carrier platform. The vacuum suction disk is located on the surface of the carrier platform and may suck and hold a carrier plate. The lifting means engages with the loading platform to drive the loading platform moving up or down. When the vacuum suction disk sucks and holds a carrier plate, the turning shaft will be turned 180 degrees to move the carrier platform and the vacuum suction disk and carrier plate facing downward, the lifting means will drive the loading platform downwards to make the chips mounted on the carrier plate to contact a silver paste tray located below the loading platform to complete dipping process.

### FIELD OF THE INVENTION

The present invention relates to an automatic dipping machine and particularly a dipping machine that is capable of automatically transport a material carrier plate to a silver paste tray to perform dipping process.

### BACKGROUND OF THE INVENTION

Multi-layer Ceramic Capacitor (MLCC) is made by forming a thin film of a thickness between 2 μM and 5 μM, or even less, from liquid which contains suspending ceramic powder, then form metal inner electrodes thereon through the silkscreen printing method. The films with the inner electrodes printed thereon and plain films that do not have inner electrodes then are stacked and compressed one upon the other alternately to become a multi-layer laminate. The laminate is heated and sintered at high temperature to become a monocrystalized substance. These processes can produce very high capacitance in a very small size. Then plate nickel, tin or lead to the silver end electrodes. The end electrodes can be soldered directly on the circuit boards. As they are small size and have high efficiency, they have been widely used in various types of electronic products.

The great demands of the ceramic capacitors have attracted a lot of producers in the MLCC (chip) market. In the mass production of the ceramic chips, the critical technology factor is the last process of dipping silver. Referring to FIG. 1, for dipping silver, the ceramic ships 10 are vertically wedged by a vibration means in the cavities of a carrier plate 12 which has 8000 cavities formed on the surface. The end electrodes of the chips are extended outwards. Then the carrier plate 12 is turned 180 degrees to make the end electrodes facing downwards to dip in a silver paste tray to complete the dipping process. Finally the chips are transported to a furnace for drying. The foregoing dipping process mostly is done by human labor. Most manufacturing facilities now being used do not have automatic dipping function. Some of them only have partial automatic capability. It becomes a great constraint to mass production and results in higher production costs. As a result, it hinders productivity improvement.

In view of aforesaid problems and concerns, many producers in the industry have invested a lot of research efforts trying to develop automatic dipping techniques and equipment to achieve the goals of increasing production efficiency and lowering labor costs in ceramic chip manufacturing.

### SUMMARY OF THE INVENTION

The primary object of the invention is to provide an automatic dipping machine for automatically transporting a material carrier plate to a silver paste tray to dip silver on the end electrodes of the chips.

The automatic dipping machine according to the present invention consists of a loading platform, a carrier platform, a vacuum suction disk and a lifting means. The loading platform is a rectangular frame with four screw bores formed at the four corners, and has two sides mounted respectively with a turning shaft and engaged with two sides of the carrier platform. The turning shafts are driven by a rotary air cylinder to turn the carrier platform. The vacuum suction disk and the carrier platform are connected by spring washers located at the four corners. On the inner sides of the carrier platform, there are a plurality of sensor means each is made in the form of a probe or the like. The vacuum suction disk may suck and hold a carrier plate. The spring washers may be used to do fine tuning adjustment of thickness to keep the carrier plate at a horizontal level and in parallel with the silver paste tray. The lifting means includes a servomotor, a cog belt and four screw bars. The four screw bars engage respectively with the screw bores in the loading platform. The servomotor may drive the cog belt to rotate the screw bars for lifting or lowering the loading platform.

When the automatic dipping machine of the invention is in use, first, the vacuum suction disk suck and hold a carrier plate, then the turning shaft is turned 180 degrees to place the carrier platform and the vacuum suction disk and carrier plate located thereon upside down, then activate the servomotor to drive the screw bars for moving the loading platform downwards until the chips on the carrier plate contact the silver paste tray located below the loading platform to complete the process of dipping silver on the end electrodes of the chips. During the carrier plate is undergoing the dipping process, if the spring washers subject to pressure resulting from obstruction of an external object, the sensor means will hit the vacuum suction disk and generate sensing signals, and alert onsite operators to take action on the external object.

By means of the construction set forth above, the automatic dipping machine of the invention can automatically transport carrier plates to the silver paste tray to perform dipping process without human labor. Thus it can increase production efficiency and save labor costs. The fine tuning adjustment of the thickness through the spring washers allows the carrier plate to maintain a horizontal level and parallel with the silver paste tray to achieve better dipping quality. The sensor means can detect obstruction of external objects and alert onsite operators to take timely action to fix the operational problems.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic side view of a carrier plate.

FIG. 2 is a perspective view of the invention.

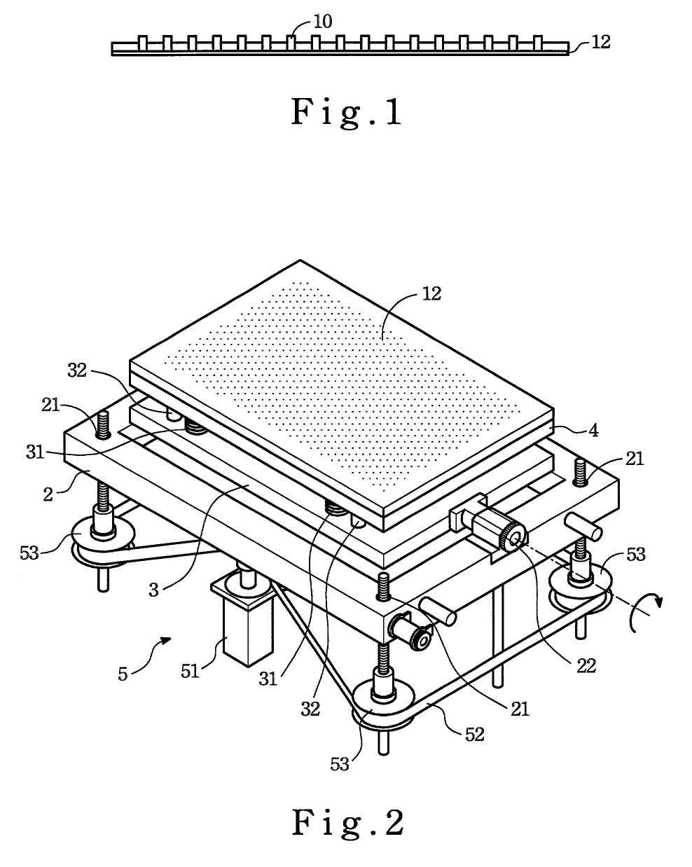

### DESCRIPTION OF THE PREFERRED EMBODIMENT

The present invention aims at providing an automatic dipping machine to automatically transport carrier plates to a silver paste tray to perform dipping process without human labor and to maintain the carrier plates at a horizontal level during dipping process, thereby to save labor cost and enhance dipping quality. The invention also is capable of detecting external objects and reduce the impact on dipping process caused by the external objects to minimum.

Referring to FIG. 2, the automatic dipping machine of the present invention includes a loading platform 2, a carrier platform 3, a vacuum suction disk 4 and a lifting means 5. The loading platform 2 is a rectangular frame with four screw bores 21 formed at four corners, and has two sides mounted respectively with a turning shaft 22 and engaged with two sides of the carrier platform 3. The turning shafts 22 are driven by a rotary air cylinder (not shown in the drawing) for turning the carrier platform 3. The vacuum suction disk 4 and the carrier platform 3 are engaged by spring washers 31 located at the four corners thereof. On the inner sides of the carrier platform 3, there are a plurality of sensor means 32 each is made in the form of a probe or the like. The vacuum suction disk 4 can suck and hold a carrier plate 12 by vacuum force. The spring washers 31 may be used to do fine tuning adjustment of the thickness to keep the carrier plate 12 at a horizontal level and in parallel with a silver paste tray (not shown in the drawing). The lifting means 5 includes a servomotor 51, a cog belt 52 and four screw bars 53. The four screw bars 53 engage respectively with the screw bores 21 in the loading platform 2. The servomotor 51 may drive the cog belt 52 to rotate the screw bars 53 for lifting or lowering the loading platform 2.

The operation of the automatic dipping machine of the invention is as follows: first, utilize the vacuum suction disk to suck and hold a carrier plate, then turn the turning shaft 180 degrees to place the carrier platform and the vacuum suction disk and carrier plate located thereon upside down, then activate the servomotor to drive the screw bars for moving the loading platform downwards until the chips on the carrier plate contact the silver paste tray located below the loading platform to complete the process of silver dipping on the end electrodes of the chips. During the carrier plate undergoing the dipping process, if there is obstruction caused by external objects (such as the vacuum suction disk sucks two carrier plates concurrently) and result in the spring washers subject to a pressure, the sensor means will hit the vacuum suction disk and generate sensing signals, and alert onsite operators to take action on the external objects.

By means of the construction set forth above, the automatic dipping machine of the invention can automatically transport carrier plates to a silver paste tray to perform dipping process without human labor. It this can increase production efficiency and save labor costs. Moreover, the spring washers provide fine tuning adjustment of the thickness and can control the carrier plates at a horizontal level during dipping process thereby enhance dipping quality. The sensor means also provide detecting external object function and allow onsite people to detect abnormal situations instantly and to take contingent measures to handle the external objects properly and timely.

While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An automatic dipping machine for automatically transport carrier plates to a silver paste tray to do silver dipping, comprising:
a loading platform being a rectangular frame and having two sides, each side having a center with a turning shaft mounted thereon;
a carrier platform having two sides which have respectively a center engaging with the turning shaft of the loading platform;
a vacuum suction disk located on the surface of the carrier platform to suck and hold the carrier plates in a vacuum suction fashion; and
a lifting means engaging with the loading platform for controlling up and down movement of the loading platform;
wherein when the vacuum suction disk sucks and holds one carrier plate, the turning shafts at the two sides of the loading platform are turned 180 degrees to make the carrier platform and the vacuum disk and the carrier plate located thereon upside down, and through the lifting means to carry the carrier plate to a silver paste tray located below the loading platform to perform dipping process.

2. The automatic dipping machine of claim 1, wherein the lifting means includes a servomotor, a cog belt and four screw bars, the four screw bars being engaged respectively with four screw bores formed in the loading platform, the servomotor driving the cog belt to rotate the screw bars for lifting or lowering the loading platform.

3. The automatic dipping machine of claim 1, wherein the turning shafts are driven by a rotary air cylinder to turn the carrier platform.

4. The automatic dipping machine of claim 1, wherein the vacuum suction disk and the carrier platform are engaged by spring washers located at four corners of the carrier platform for fine tuning adjustment of thickness to keep the carrier plate horizontal and in parallel with the silver paste tray surface.

5. The automatic dipping machine of claim 4, wherein the carrier platform has inner sides which have a plurality of sensor means located thereon to generate induction for alerting operators to take actions when the spring washers subject to a pressure resulting from obstruction of an external object when the carrier plate is undergoing the dipping process.
